(19) United States
(12) Patent Application Publication
(10) Pub. No.: US 2018/0117700 A1
(43) Pub. Date: May 3, 2018

(54) METHOD FOR WELDING DISSIMILAR METALS

(71) Applicant: NATIONAL SYNCHROTRON RADIATION RESEARCH CENTER, Hsinchu (TW)

(72) Inventors: CHIN-CHUN CHANG, HSINCHU (TW); CHIN SHUEH, HSINCHU (TW); LING-HUI WU, HSINCHU (TW); CHE-KAI CHAN, HSINCHU (TW); I CHING ALBERT SHENG, HSINCHU (TW); CHIEN-KUANG KUAN, HSINCHU (TW)

(21) Appl. No.: 15/408,918

(22) Filed: Jan. 18, 2017

Related U.S. Application Data
(60) Provisional application No. 62/417,092, filed on Nov. 3, 2016.

(51) Int. Cl. B23K 9/23; B23K 9/02

(52) U.S. Cl. CPC B23K 9/232; B23K 2203/22; B23K 9/0216

(57) ABSTRACT

A method for welding dissimilar metals is provided. A first metal workpiece and a second metal workpiece having different physical characteristics are provided. A surface of the first metal workpiece and a surface of the second metal workpiece are abutted to form a pre joint surface between the first metal workpiece and the second metal workpiece. The first metal workpiece and the second metal workpiece are welded with a welding apparatus moving substantially along an axis, wherein the axis is offset from the pre-joint surface and proximal to the first metal workpiece than to the second metal workpiece.

This application claims priority of U.S. provisional application Ser. No. 62/417,092 filed on 3 Nov. 2016, which is incorporated by reference in its entirety.

### TECHNICAL FIELD

The present disclosure relates to a method for welding dissimilar metals, and more particularly, to a method for welding metals of different physical characteristics.

### DISCUSSION OF THE BACKGROUND

Dissimilar metals (also referred to as heterogeneous metals) are different in physical characteristics such as in coefficients of thermal conductivity, mechanical properties and melting points, and the dissimilar metals are difficult to weld because defects due to stress concentration and welding crack tend to occur during welding. Conventionally, electron beam (EB) welding is used to weld dissimilar metals. However, EB welding machine is expensive, and there is a limit of the size of metals to be welded. Vacuum furnace brazing, another conventional welding method, also suffers high cost and size limitation. Also, the mechanical strength of metals after welding in high temperature will be weakened.

This “Discussion of the Background” section is provided for background information only. The statements in this “Discussion of the Background” are not an admission that the subject matter disclosed in this “Discussion of the Background” section constitutes prior art to the present disclosure, and no features of this “Discussion of the Background” section may be used as an admission that any features of this application, including this “Discussion of the Background” section, constitutes prior art to the present disclosure.

### SUMMARY

One aspect of the present disclosure provides a method for welding dissimilar metals of different physical characteristics.

A method for welding dissimilar metals according to some embodiments of the present disclosure includes the following steps. A first metal workpiece and a second metal workpiece having different physical characteristics are provided. A surface of the first metal workpiece and a surface of the second metal workpiece are abutted to form a pre joint surface between the first metal workpiece and the second metal workpiece. The first metal workpiece and the second metal workpiece are welded with a welding apparatus moving substantially along an axis, wherein the axis is offset from the pre joint surface and proximal to the first metal workpiece than to the second metal workpiece.

In some embodiments, the first metal workpiece has a first coefficient of thermal conductivity, and the second metal workpiece has a second coefficient of thermal conductivity lower than the first coefficient of thermal conductivity;

In some embodiments, the welding apparatus comprises an arc welding apparatus.

In some embodiments, the arc welding apparatus comprises a gas tungsten arc welding (GTAW) apparatus.

In some embodiments, the axis is substantially in parallel with the pre joint surface.

In some embodiments, the pre joint surface is a planar surface.

In some embodiments, the pre joint surface has a ring shape.

In some embodiments, the first metal workpiece and the second metal workpiece are plate workpieces.

In some embodiments, the first metal workpiece and the second metal workpiece are pipe workpieces.

In some embodiments, one of the first metal workpiece or the second metal workpiece is a plate workpiece, and the other one of the first metal workpiece or the second metal workpiece is a pipe workpiece.

In some embodiments, a material of the first metal workpiece comprises copper or an alloy thereof.

In some embodiments, the material of the first metal workpiece comprises copper chromium zirconium (CuCrZr) alloy, or oxygen-free high conductivity (OFHC) copper.

In some embodiments, a material of the second metal workpiece comprises stainless steel (SS).

In some embodiments, the welding apparatus is moved in a straightforward path along the axis.

In some embodiments, the welding apparatus is moved in a zigzag path along the axis.

In some embodiments, the pre joint surface is a seamless surface.

The method for welding dissimilar metals with differences in coefficients of thermal conductivity uses a welding apparatus moving along an axis deviated from the pre joint surface of dissimilar metals. The welding with the welding apparatus deviated from the pre joint surface of dissimilar metals is able to compensate for the differences in physical characteristics between the dissimilar metals, and thus allows the metal with higher coefficient of thermal conductivity to obtain sufficient heat to be in a fusion state without overheating the metal with lower coefficient of thermal conductivity. Consequently, generation of defects is inhibited, and thus the welded dissimilar metals possess better joint surface, better vacuum sealing effect and mechanical strength. With the high vacuum sealing effect and mechanical strength, the welded dissimilar metals are applicable in various devices such as semiconductor device, high thermal loading device such as accelerator or nuclear-related device, and high precision industrial device. The method for welding dissimilar metals is also advantageous for its reduced costs and high yield.

The foregoing has outlined rather broadly the features and technical advantages of the present disclosure in order that the detailed description of the disclosure that follows may be better understood. Additional features and advantages of the disclosure will be described hereinafter, which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 is a flow chart illustrating a method for welding dissimilar metals in accordance with some embodiments of the present disclosure;

FIG. 2A, FIG. 2B, FIG. 2C, FIG. 2D, FIG. 2E, FIG. 2F and FIG. 2G are schematic diagrams at one of various steps of a method for welding dissimilar metals according to some embodiments of the present disclosure;

FIG. 3 is a schematic diagram illustrating a method for welding dissimilar metals according to some embodiments of the present disclosure;

FIG. 4A, FIG. 4B, FIG. 4C and FIG. 4D are schematic diagrams at one of various steps of a method for welding dissimilar metals according to some embodiments of the present disclosure;

FIG. 5A, FIG. 5B, FIG. 5C and FIG. 5D are schematic diagrams at one of various steps of a method for welding dissimilar metals according to some embodiments of the present disclosure;

FIG. 6 is a microscope view of a welded specimen of CuCrZr and stainless steel in accordance with some embodiments of the present disclosure;

FIG. 7A, FIG. 7B and FIG. 7C are microscope cross-sectional views of a welded specimen of CuCrZr and stainless steel in accordance with some embodiments of the present disclosure;

FIG. 8A, FIG. 8B, FIG. 8C and FIG. 8D are EDX mappings of mixed grains;

FIG. 9A and FIG. 9B show the results of a tensile test before and after CuCrZr/SS and OFHC/SS welding, respectively; and

FIG. 10A and FIG. 10B show the stress-strain diagram of tensile tests of the CuCrZr/SS and OFHC/SS joints, respectively.

### DETAILED DESCRIPTION

The following description of the disclosure accompanies drawings, which are incorporated in and constitute a metal workpiece of this specification, and illustrate embodiments of the disclosure, but the disclosure is not limited to the embodiments. In addition, the following embodiments can be properly integrated to complete another embodiment.

References to “one embodiment,” “an embodiment,” “exemplary embodiment,” “some embodiments,” “other embodiments,” “another embodiment,”, etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present disclosure is directed to a method for welding dissimilar metals. In order to make the present disclosure completely comprehensible, detailed steps and structures are provided in the following description. Obviously, implementation of the present disclosure does not limit special details known by persons skilled in the art. In addition, known structures and steps are not described in detail, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

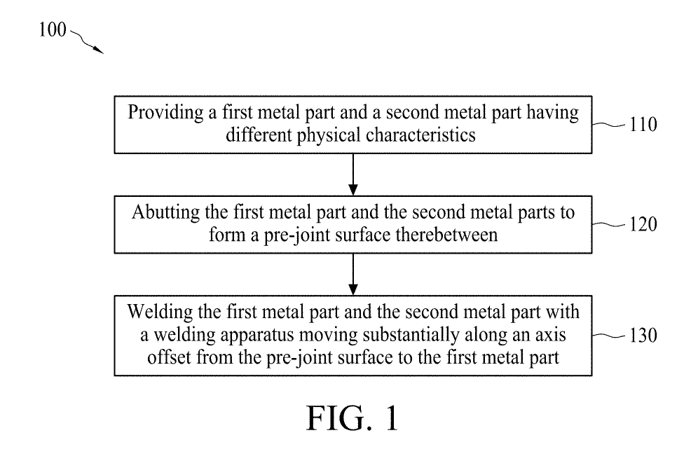

FIG. 1 is a flow chart illustrating a method for welding dissimilar metals in accordance with some embodiments of the present disclosure. The method 100 begins with operation 110 in which a first metal workpiece and a second metal workpiece having different physical characteristics are provided. The method 100 continues with operation 120 in which the first metal workpiece and the second metal workpieces are abutted to form a pre joint surface therebetween. The method 100 proceeds with operation 130 in which the first metal workpiece and the second metal workpiece are welded by moving a welding apparatus substantially along an axis offset from the pre joint surface to the first metal workpiece.

The method 100 is merely an example, and is not intended to limit the present disclosure beyond what is explicitly recited in the claims. Additional operations can be provided before, during, and after the method 100, and some operations described can be replaced, eliminated, or moved around for additional embodiments of the method.

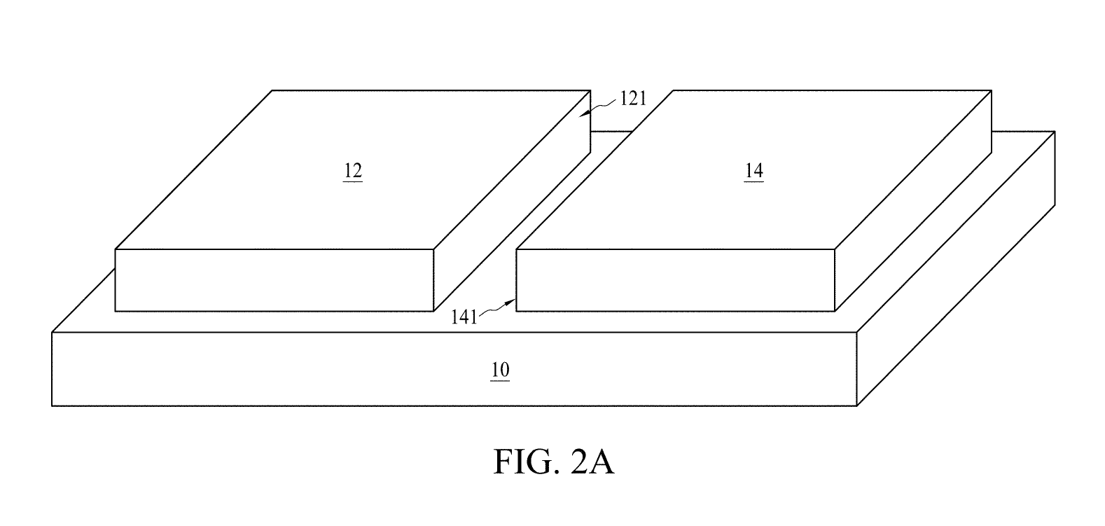

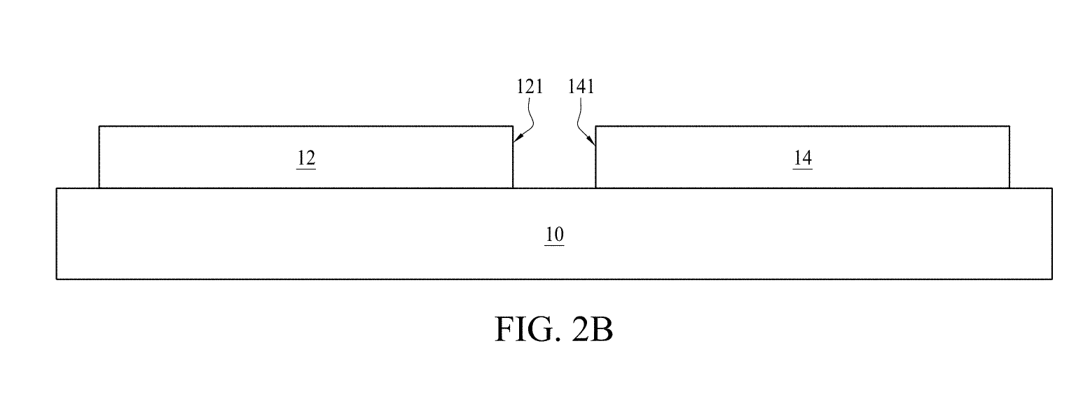

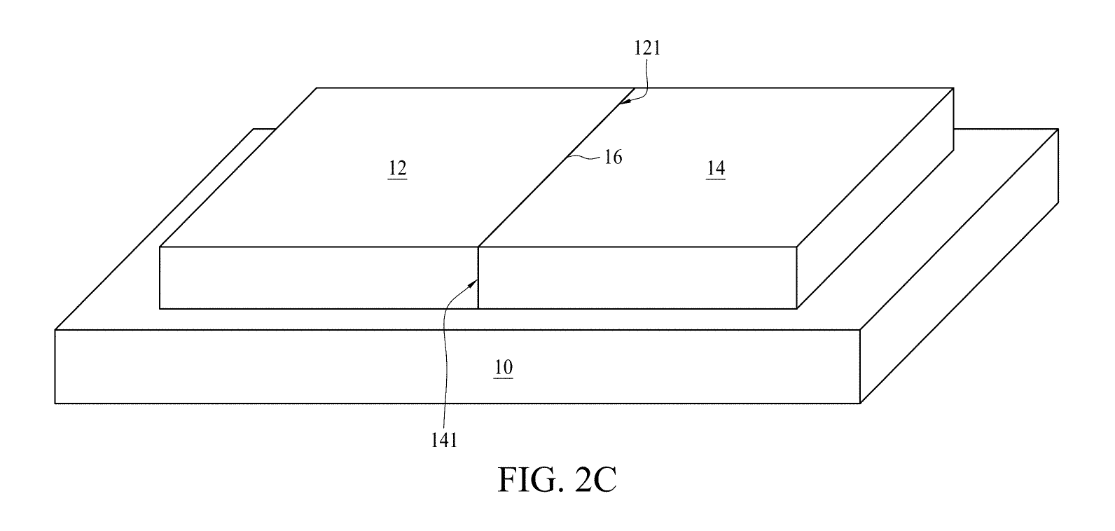

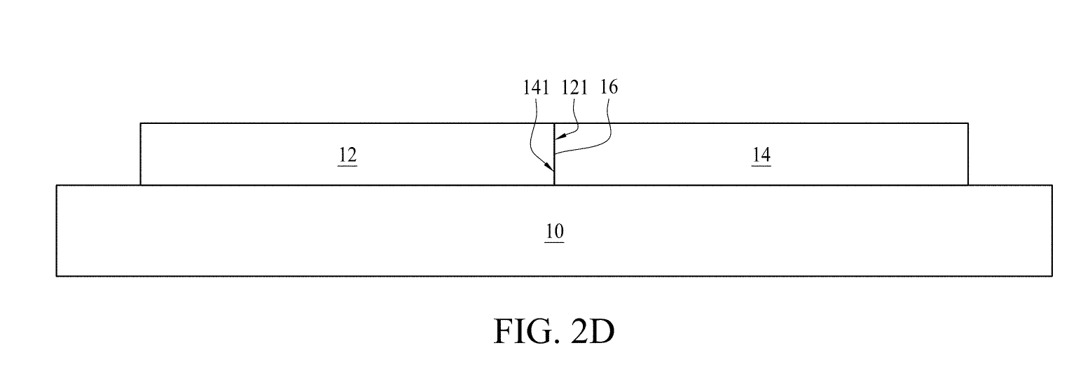

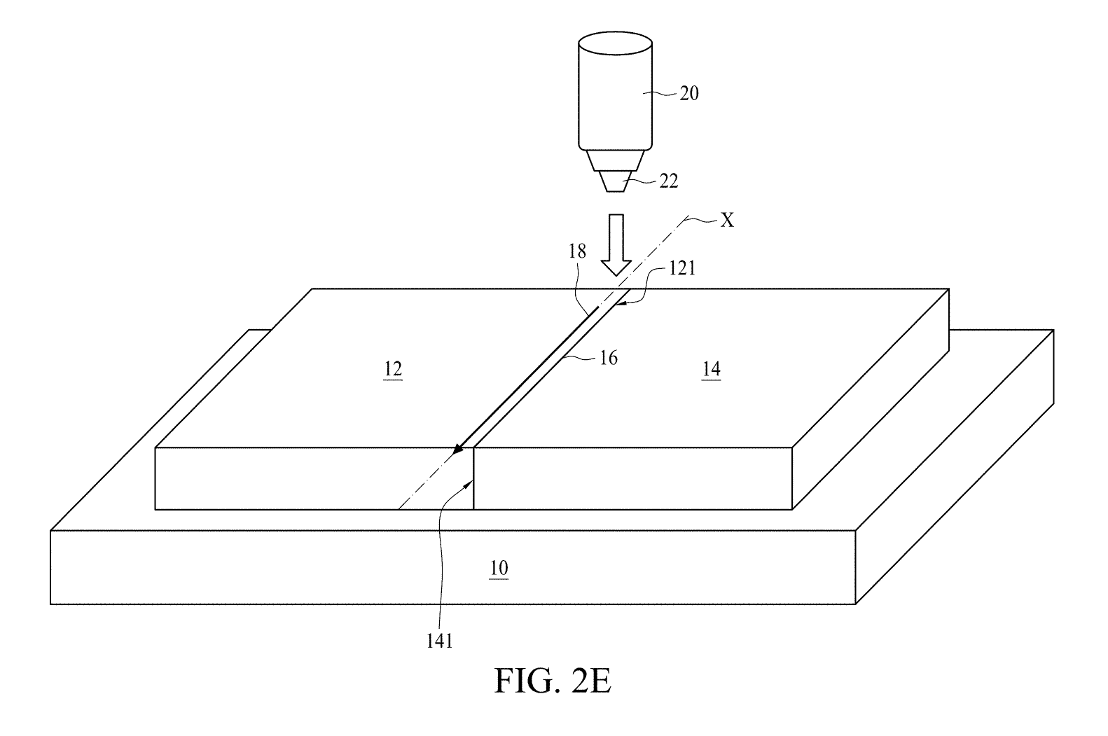

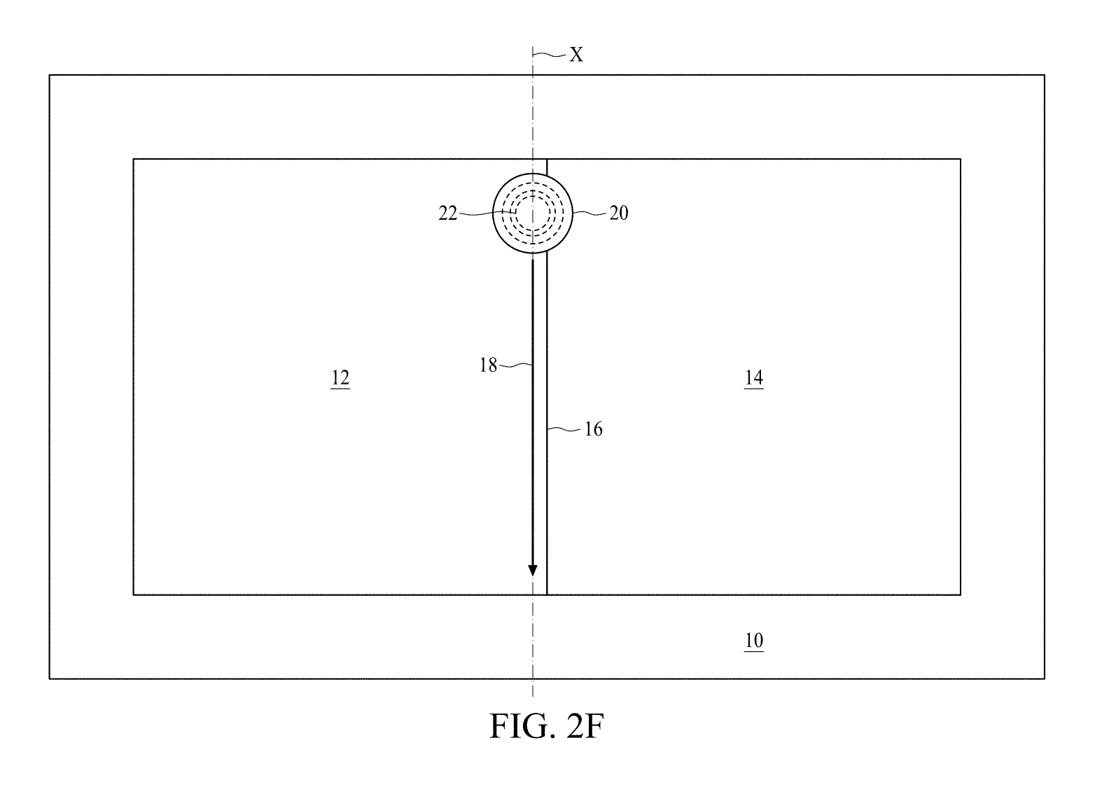

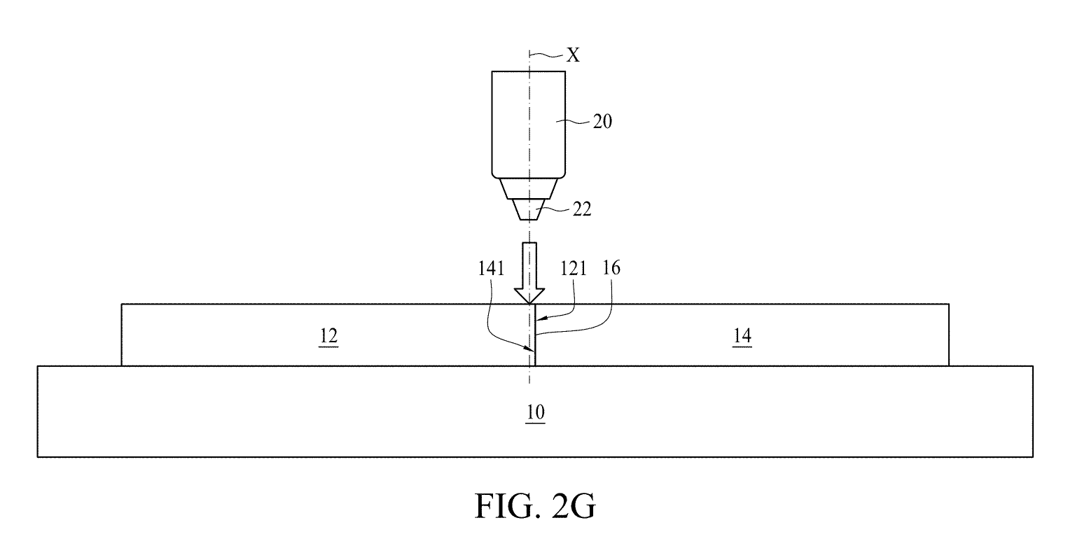

FIG. 2A, FIG. 2B, FIG. 2C, FIG. 2D, FIG. 2E, FIG. 2F and FIG. 2G are schematic diagrams at one of various steps of a method for welding dissimilar metals according to one or more embodiments of the present disclosure, where FIG. 2A, FIG. 2C and FIG. 2E are perspective views, FIG. 2B, FIG. 2D and FIG. 2G are side views, and FIG. 2F is a top view. Referring to FIG. 2A and FIG. 2B, a first metal workpiece 12 and a second metal workpiece 14 to be welded are provided. The first metal workpiece 12 and the second metal workpiece 14 are dissimilar metals (also referred to as heterogeneous metals) and are different in some physical characteristics. In some embodiments, the first metal workpiece 12 has a first coefficient of thermal conductivity, and the second metal workpiece 14 has a second coefficient of thermal conductivity lower than the first coefficient of thermal conductivity. In some embodiments, a ratio of the first coefficient of thermal conductivity to the second coefficient of thermal conductivity is, but not limited to be, over 10 or even over 20. In some embodiments, the first metal workpiece 12 and the second metal workpiece 14 are also different in some other physical characteristics such as coefficient of thermal expansion, mechanical property and melting point. In some embodiments, the first metal workpiece 12 and the second metal workpiece 14 may be similar in some physical characteristics such as atomic radius, crystal lattice and lattice constant. By way of example, the material of the first metal workpiece 12 includes, but is not limited to, copper (Cu), an alloy of copper such as copper chromium zirconium (CuCrZr) alloy, or oxygen-free high conductivity (OFHC) copper; the material of the second metal workpiece 14 includes, but is not limited to, stainless steel (SS). In some embodiments, the first metal workpiece 12 and the second metal workpiece 14 are placed and fixed on a stage 10.

Referring to FIG. 2C and FIG. 2D, a surface 121 of the first metal workpiece 12 and a surface 141 of the second metal workpiece 14 are abutted and in contact with each other to form a pre-joint surface 16. In some embodiments, the surface 121 and the second surface 141 are treated or machined by e.g., grinding, polishing, milling or the like such that the surface 121 and the second surface 141 can be tightly abutted to form a seamless surface. In some embodiments, the first metal workpiece 12 and the second metal workpiece 14 are both plate workpieces, and each of the first surface 121 and the second surface 141 is an edge surface. Accordingly, the pre-joint surface 16 is a planar surface. In some embodiments, the first surface 121 or the second surface 141 may be a main surface such as a front surface or a back surface of the plate workpiece.

Referring to FIG. 2E, FIG. 2F and FIG. 2G, the first metal workpiece 12 and the second metal workpiece 14 are welded with a welding apparatus 20. The welding apparatus 20 is configured to provide sufficient heat source to melt the first metal workpiece 12 and the second metal workpiece 14, converting the first metal workpiece 12 and the second metal workpiece 14 into a fusion state (molten state). In some embodiments, the welding apparatus 20 is, but not limited to, an arc welding apparatus such as a gas tungsten arc welding (GTAW) apparatus, plasma arc welding (PAW) apparatus, or the like. During welding operation, the welding apparatus 20 is operated to move substantially along an axis X, where the axis X is offset from the pre-joint surface 16 and proximal to the first metal workpiece 12 than to the second metal workpiece 14. In some embodiments, the axis X is substantially in parallel with the pre joint surface 16. In some embodiments, the axis X is a linear axis substantially in parallel with the planar pre joint surface 16. In some embodiments, the welding apparatus 20 is moved in a straightforward path 18 along the axis X, and the straightforward path 18 is a linear path substantially overlapping the axis X.

The welding apparatus 20 is moving along the axis X closer to the first metal workpiece 12 than the second metal workpiece 14, and thus the first metal workpiece 12 with higher coefficient of thermal conductivity is supplied with more heat source than the second metal workpiece 14 with lower coefficient of thermal conductivity. This heat distribution is configured to compensate for the difference in physical characteristics between the first metal workpiece 12 and the second metal workpiece 14, and thus allows the first metal workpiece 12 to obtain sufficient heat to be in a fusion state without overheating the second metal workpiece 14. Accordingly, generation of defects is inhibited, and thus vacuum sealing effect and mechanical strength of the first metal workpiece 12 and the second metal workpiece 14 after welding are enhanced.

In some embodiments, the welding apparatus 20 includes an electrode 22 configured as a torch tip having a diameter. In some embodiments, the offset of the axis X is about ⅔ of the diameter of the electrode 22, but not limited thereto. The offset between the axis X and the pre-joint surface 16 can be modified based on the physical characteristic relation between the first metal workpiece 12 and the second metal workpiece 14 such as the ratio of coefficient of thermal conductivity of the first metal workpiece 12 to that of the second metal workpiece 14.

In some embodiments, the first metal workpiece 12 and the second metal workpiece 14 are similar in some physical characteristics such as atomic radius, crystal lattice and lattice constant. Accordingly, the first metal workpiece 12 and the second metal workpiece 14 are miscible in fusion state, and generation of brittle intermetallic compound can be inhibited after the first metal workpiece 12 and the second metal workpiece 14 are welded.

In some embodiments, the welded metal workpiece 12 and second metal workpiece 14 are applicable in various device such as semiconductor device, high thermal loading device such as accelerator, absorber or nuclear-related devices, and high precision industrial device.

The method for welding dissimilar metals of the present disclosure is not limited to the above-mentioned embodiments, and may have other different embodiments. To simplify the description and for the convenience of comparison between each of the embodiments of the present disclosure, the same components in each of the following embodiments are marked with same numerals.

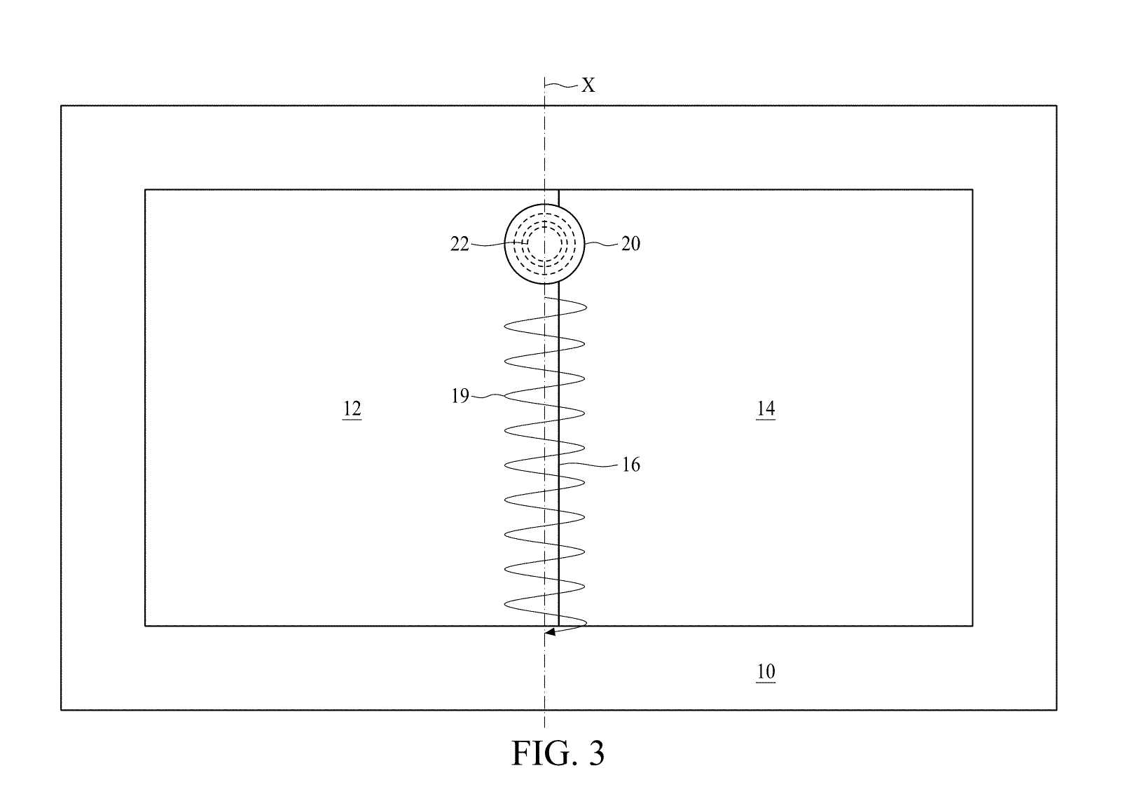

FIG. 3 is a schematic diagram illustrating a method for welding dissimilar metals according to some embodiments of the present disclosure. Referring to FIG. 3, the welding apparatus 20 is moved in a zigzag path 19 or in a spiral path along the axis X during welding. In some embodiments, the zigzag path 19 is a path winding across the axis X, and the axis X can be regarded as a symmetrical axis to the zigzag path 19. In some embodiments, the zigzag path 19 of the welding apparatus 20 creates micro disturbance in the molten pool formed by melting metals, which helps to mix the metals more uniformly, and thus the dissimilar metals can be jointed more thoroughly.

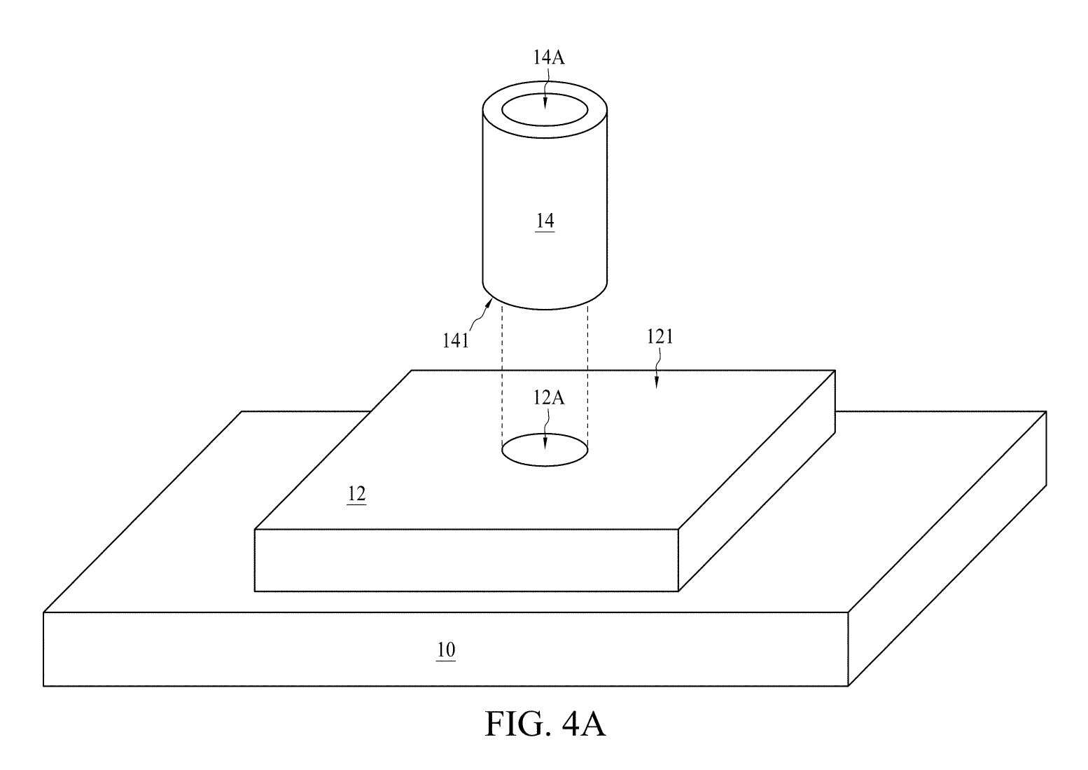

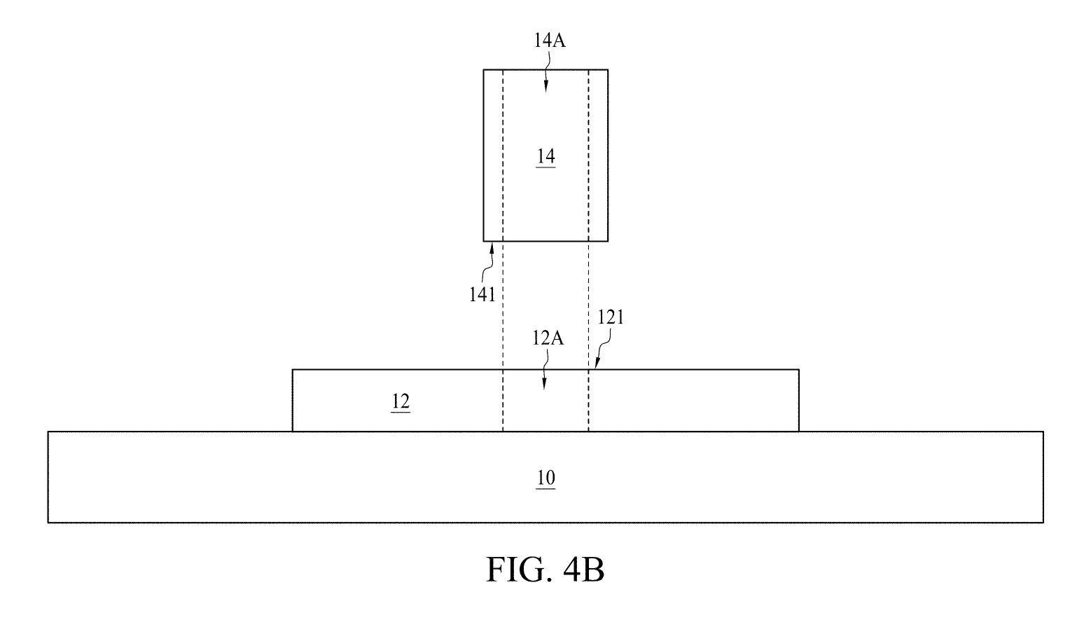

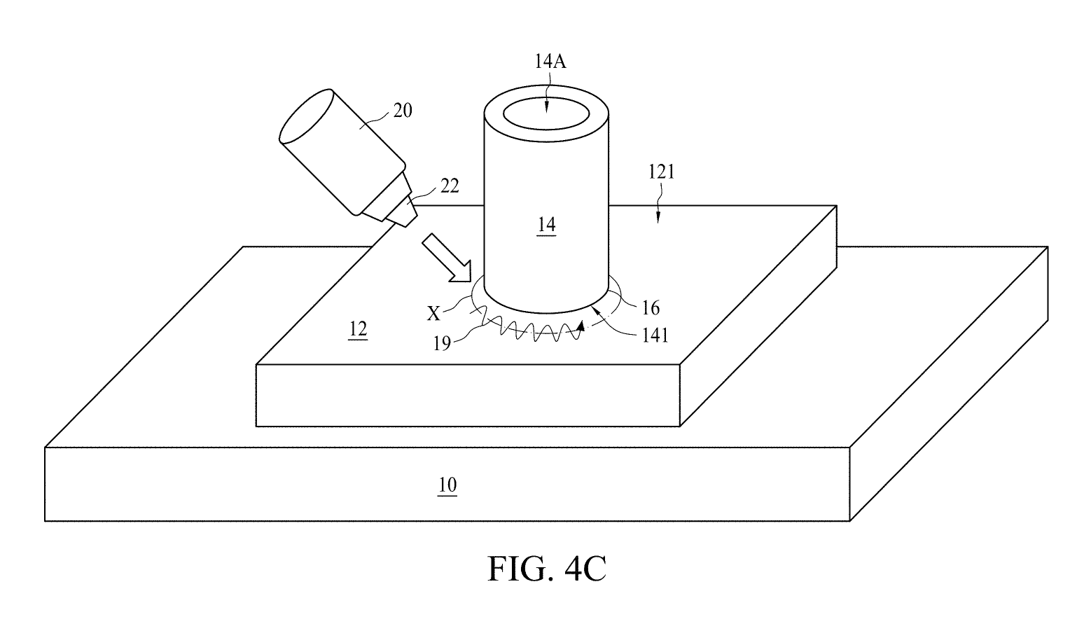

FIG. 4A, FIG. 4B, FIG. 4C and FIG. 4D are schematic diagrams at one of various steps of a method for welding dissimilar metals according to some embodiments of the present disclosure, where FIG. 4A and FIG. 4C are perspective views, and FIG. 4B and FIG. 4D are side views. Referring to FIG. 4A and FIG. 4B, the first metal workpiece 12 is a plate workpiece having a hole 12A, and the second metal workpiece 14 is a pipe (tube) workpiece having a channel 14A. In some embodiments, the pipe workpiece is, but not limited to, a round pipe. The pipe workpiece may also be a square pipe or a pipe of any other shape. In some embodiments, the first coefficient of thermal conductivity of the first metal workpiece 12 is higher than the second coefficient of thermal conductivity of the second metal workpiece 14.

Referring to FIG. 4C and FIG. 4D, the first surface 121 of the first metal workpiece 12 and the second surface 141 of the second metal workpiece 14 are abutted to form a pre joint surface 16. Given that the second metal workpiece 14 is a round pipe, the pre joint surface 16 has a ring shape. Subsequently, the first metal workpiece 12 and the second metal workpiece 14 are welded with the welding apparatus 20. During welding operation, the welding apparatus 20 is operated to move substantially along the axis X, where the axis X is offset from the pre-joint surface 16 and proximal to the first metal workpiece 12 than to the second metal workpiece 14. Since the pre joint surface 16 is ring-shaped, the axis X is a non-linear axis such as a circular axis. In some exemplary embodiments, the welding apparatus 20 is moved in a zigzag path 19 or a spiral path along the axis X during welding. In some exemplary embodiments, the welding apparatus 20 is moved in a straightforward path along the axis X during welding.

In some alternative embodiments, the first metal workpiece 12 is a pipe workpiece, and the second metal workpiece 14 is a plate workpiece. In such a case, the axis X is offset from the pre joint surface 16 and proximal to the pipe workpiece (the first metal workpiece 12) than to the plate workpiece (the second metal workpiece 14).

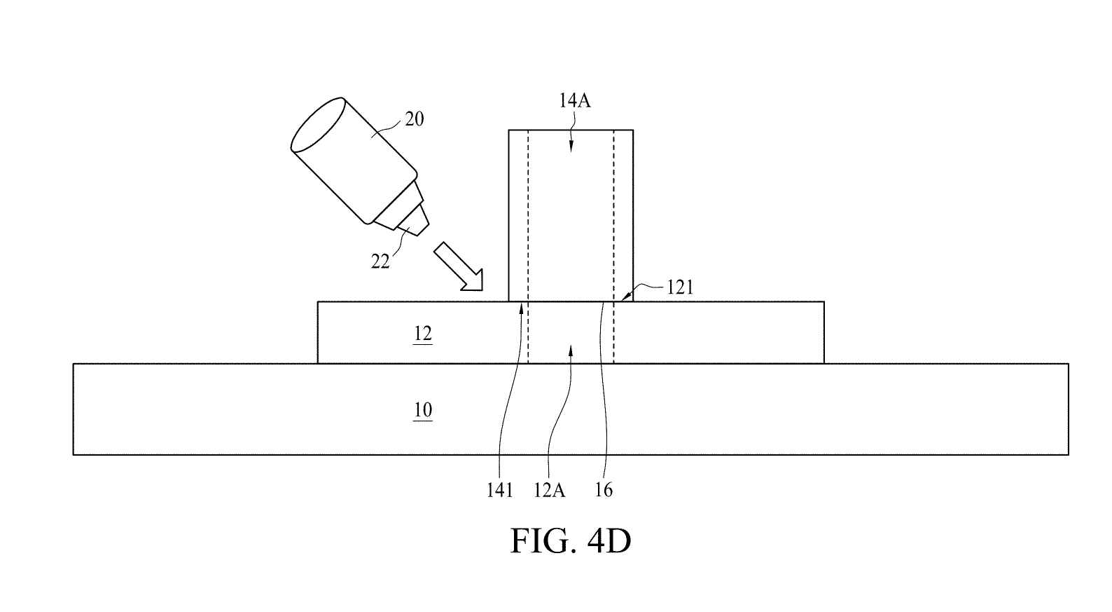

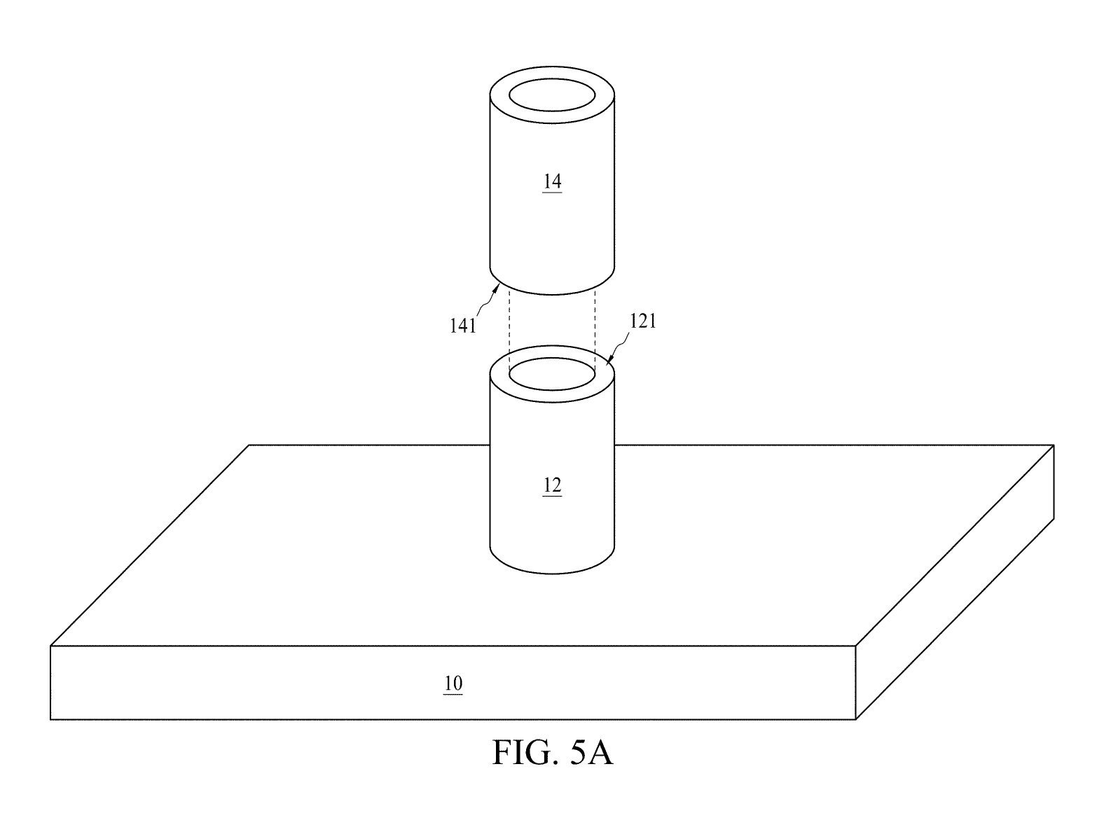

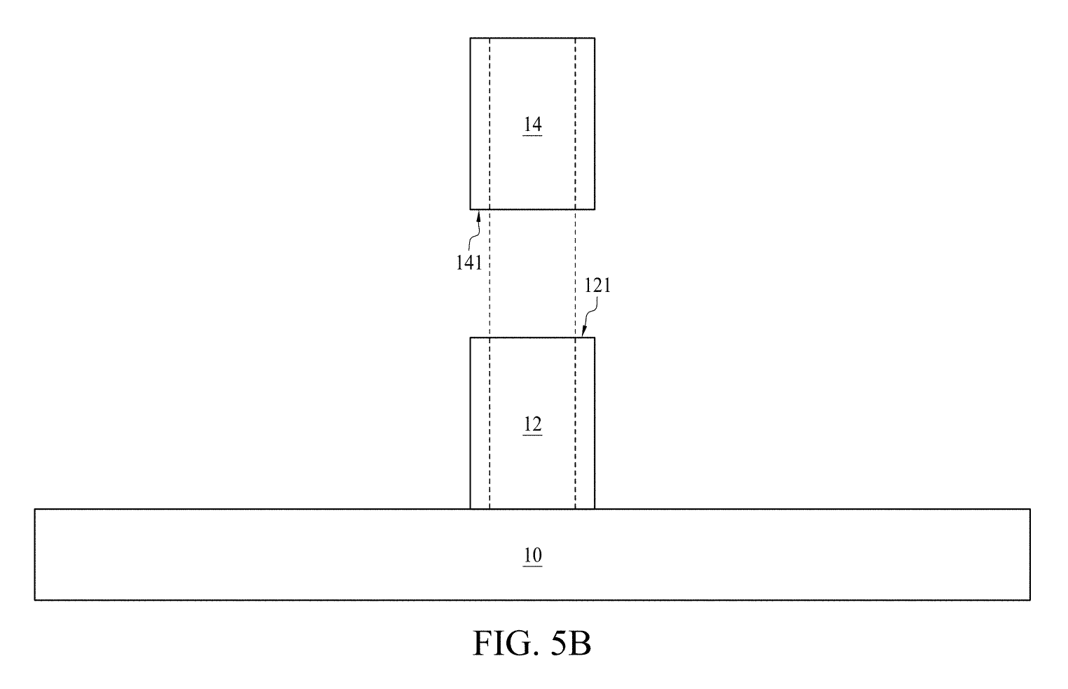

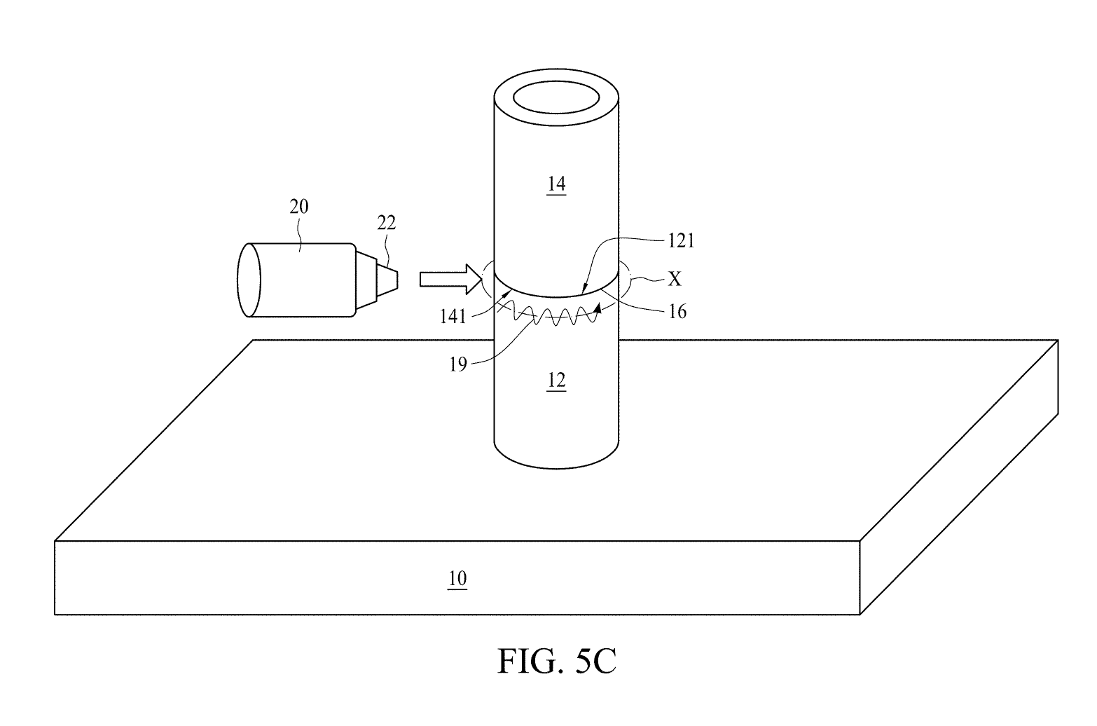

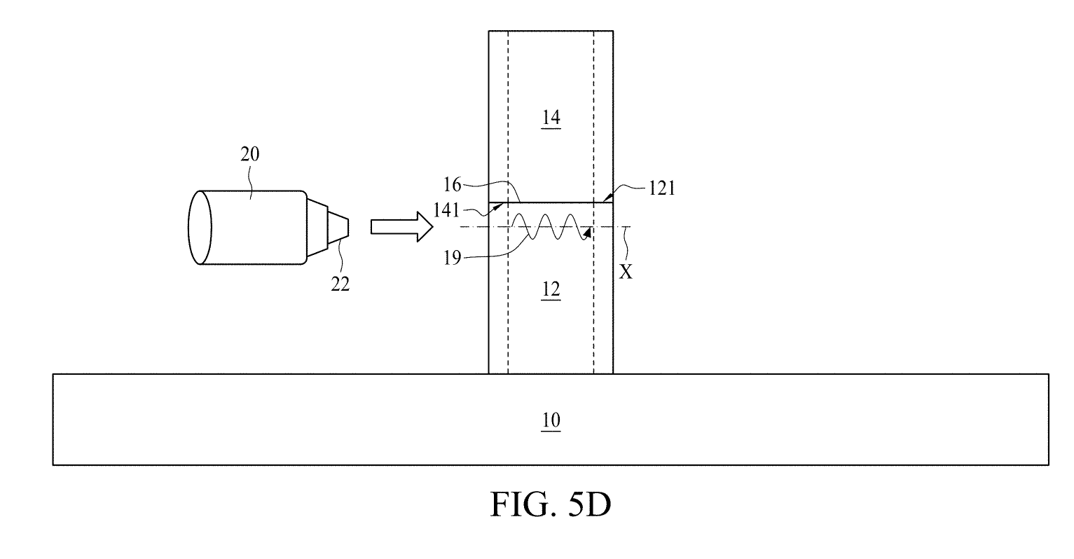

FIG. 5A, FIG. 5B, FIG. 5C and FIG. 5D are schematic diagrams at one of various steps of a method for welding dissimilar metals according to some embodiments of the present disclosure, where FIG. 5A and FIG. 5C are perspective views, and FIG. 5B and FIG. 5D are side views. Referring to FIG. 5A and FIG. 5B, the first metal workpiece 12 and the second metal workpiece 14 are both pipe workpieces. In some embodiments, the pipe workpiece is, but not limited to, a round pipe. The pipe workpiece may also be a square pipe or a pipe of any other shape. In some embodiments, the first coefficient of thermal conductivity of the first metal workpiece 12 is higher than the second coefficient of thermal conductivity of the second metal workpiece 14.

Referring to FIG. 5C and FIG. 5D, the first surface 121 of the first metal workpiece 12 and the second surface 141 of the second metal workpiece 14 are abutted to form a pre joint surface 16. Subsequently, the first metal workpiece 12 and the second metal workpiece 14 are welded with the welding apparatus 20. During welding operation, the welding apparatus 20 is operated to move substantially along the axis X, where the axis X is offset from the pre-joint surface 16 and proximal to the first metal workpiece 12 than to the second metal workpiece 14. In some exemplary embodiments, the welding apparatus 20 is moved in a zigzag path 19 or a spiral path along the axis X during welding. In some exemplary embodiments, the welding apparatus 20 is moved in a straightforward path along the axis X during welding.

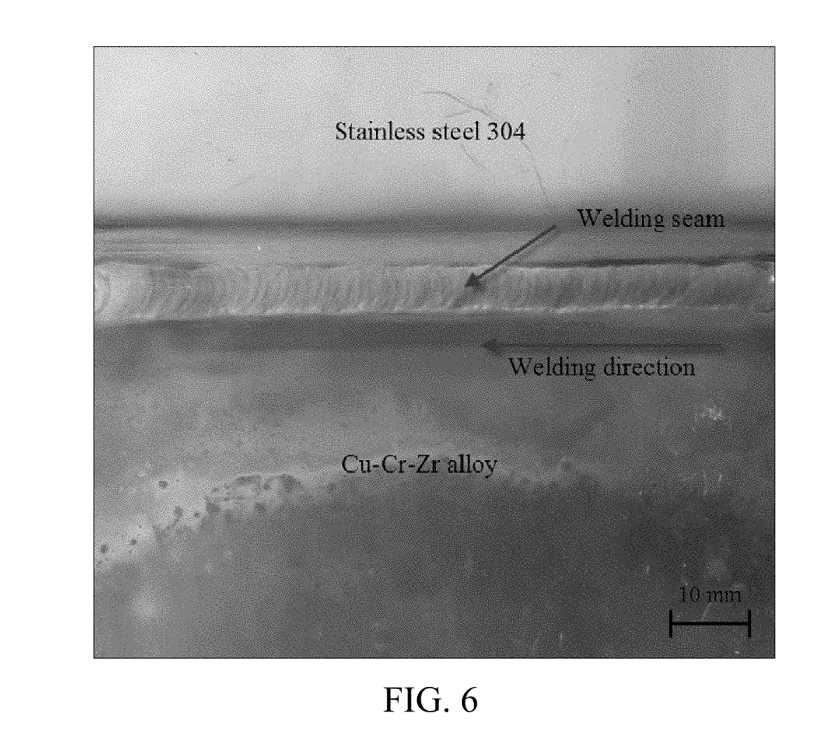

FIG. 6 is a microscope view of a welded specimen of CuCrZr and stainless steel in accordance with some embodiments of the present disclosure. Referring to FIG. 6, the morphology of the dissimilar metals (CuCrZr and stainless steel) shows that the joint of the dissimilar metals is seamless, and welding defects are effectively inhibited by the welding method of the present disclosure.

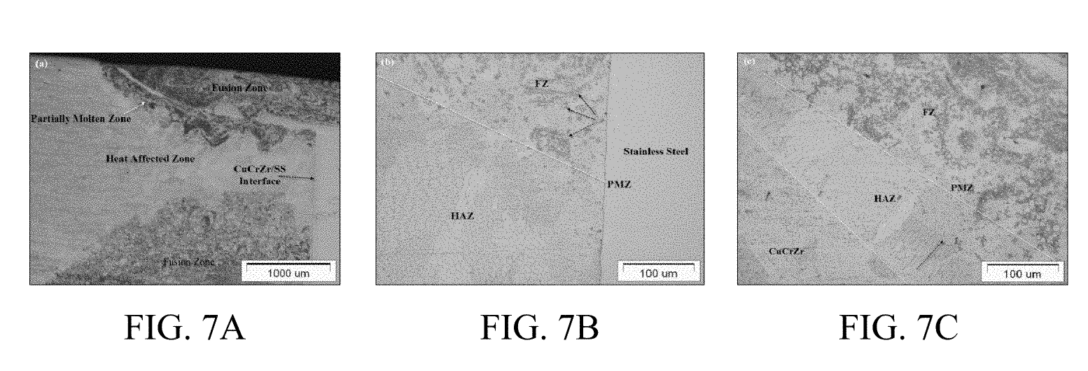

FIG. 7A, FIG. 7B and FIG. 7C are microscope cross-sectional views of a welded specimen of CuCrZr and stainless steel in accordance with some embodiments of the present disclosure. Referring to FIG. 7A, FIG. 7B and FIG. 7C, a heat affective zone (HAZ) is formed between CuCrZr alloy grain boundary and stainless steel fusion zone (FZ). Stainless steel particles are surrounded by CuCrZr copper matrix. It is believed that stainless steel particles behave as slipping obstacles along the copper grain boundaries to enhance material strength. FIG. 7A, FIG. 7B and FIG. 7C indicate the increasing trend of the CuCrZr alloy grain size in the HAZ, mainly from the influence of the input heat in the welding process. Additionally, in the HAZ, the orientation of dendrites grew along the direction of the welding pool. Also, the size of a great portion of mixed composition is smaller than about 10 micrometers. These mixtures were mainly formed from the joint of stainless steel and copper alloy produced by the welding process such as GTAW process. The structures of most mixtures are similar to the stainless-steel structure, which shows the components are effectively melted within the welding pool.

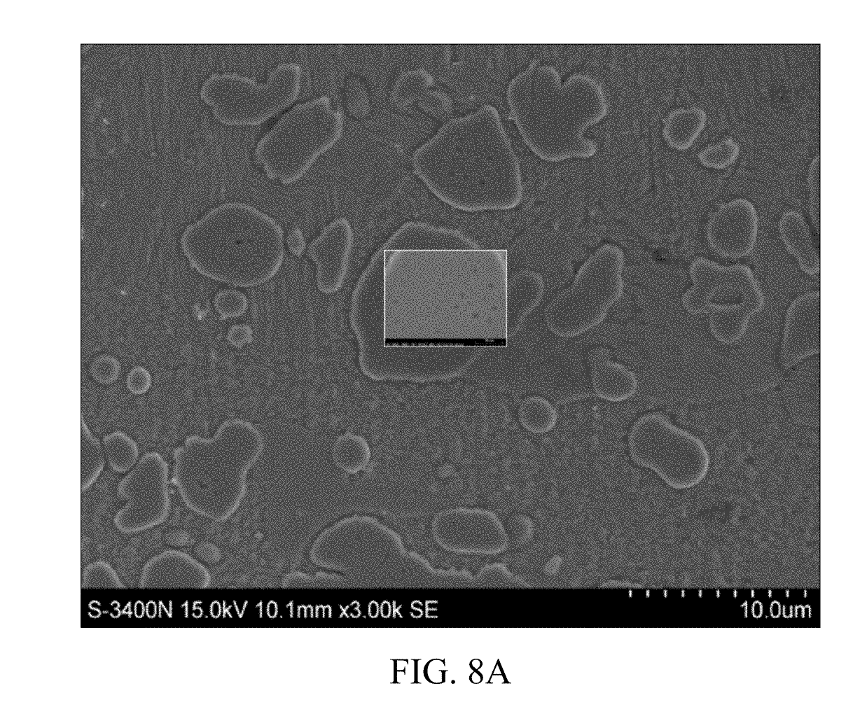

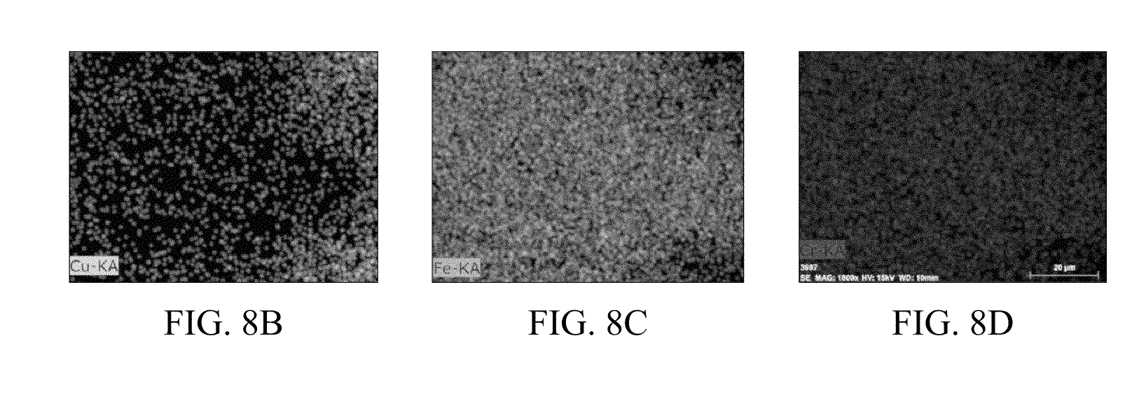

FIG. 8A, FIG. 8B, FIG. 8C and FIG. 8D are EDX mappings of mixed grains. FIG. 8A shows the distribution of the mixture spread in the fusion zone. These mixture compositions are equiaxed cluster grains of size ranging from about 2 micrometers to about 7 micrometers. With SEM-EDX plane mapping for analysis of the internal elements of the equiaxed cluster grain, the EDX mapping results indicated that the grains have considerable copper composition in the welding pool on the copper side as shown in FIG. 8B. Also, the EDX mapping results also indicated that the grains have considerable iron and chromium composition in the welding pool on the copper side as shown in FIGS. 8C and 8D. This feature indicates that the elements of stainless steel are mutually soluble in the copper substrate, and confirmed that the CuCrZr/SS or OFHC/SS can form a good dissimilar joint.

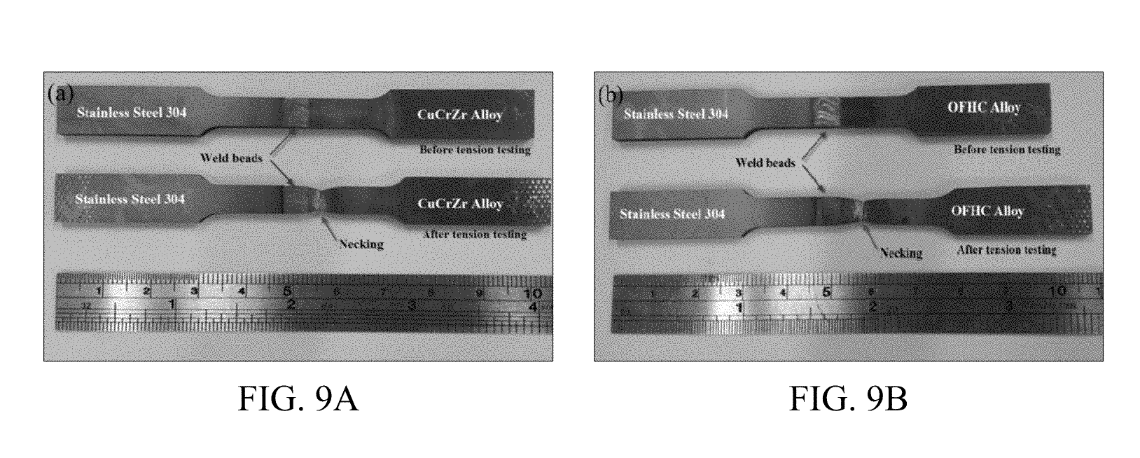

The welded specimens were machined to form the tension test samples. FIG. 9A and FIG. 9B show the results of a tensile test before and after CuCrZr/SS and OFHC/SS welding, respectively. A necking phenomenon appeared at the fracture position. In all test samples the fracture appeared in the HAZ position on the copper side. The results also indicated that the copper alloy side has a serious heating effect, leading to coarse grains in the HAZ, and then that the tensile mechanical properties decreased. Additionally, we compared the CuCrZr/SS and OFHC/SS dissimilar welding to show which elongation ratio has a larger difference. The results indicated that the elongation ratio of the OFHC/SS joint was greater than that of the CuCrZr/SS joint, respectively 23.6% and 12.5%. This result represents the ability of softened resistance strength for copper alloy of these two kinds and also indicates that the pure material has a larger deformation ability that its mechanical properties are unable to maintain.

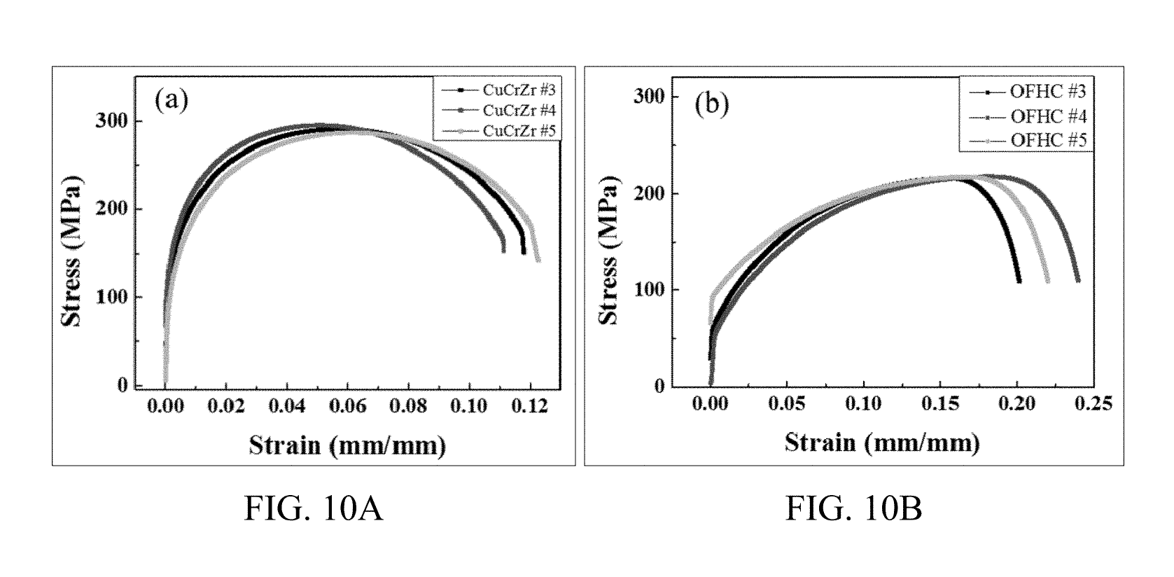

FIG. 10A and FIG. 10B show the stress-strain diagram of tensile tests of the CuCrZr/SS and OFHC/SS joints, respectively. The tensile strength of joints of these two kinds has been evaluated. At each joint, three specimens were tested; the average tensile strengths of three specimens were recorded. The average tensile stresses, 300 MPa of CuCrZr/SS and 220 MPa of the OFHC/SS joints were measured. The CuCrZr/SS joint tensile stress was compared with the CuCrZr alloy base material (460 MPa), which has a tensile stress ranged from 65% to 70%. The same result was observed in the OFHC/SS joint tensile stress comparison with OFHC base material (310 MPa). These results show that the mechanical strength of the joint has attained the level of using the GTAW method. In general, these dissimilar joints not only have obtained successful welds but also can provide further more real industrial technology designs.

The embodiments of the present disclosure provide methods for welding dissimilar metals with differences in physical characteristics such as in coefficients of thermal conductivity by welding the dissimilar metals along an axis deviated from the pre joint surface of dissimilar metals. The deviated welding method is able to compensate for the difference in physical characteristics between the dissimilar metals, and thus allows the metal with higher coefficient of thermal conductivity to obtain sufficient heat to be a fusion state without overheating the metal with lower coefficient of thermal conductivity. Consequently, generation of defects is inhibited, and thus the welded dissimilar metals possess better joint surface, better vacuum sealing effect and mechanical strength. With the high vacuum sealing effect and mechanical strength, the welded dissimilar metals are applicable in various devices such as semiconductor device, high thermal loading device such as accelerator or nuclear-related device, and high precision industrial device. The method for welding dissimilar metals is also advantageous for its reduced costs and high yield.

In some embodiments, a method for welding dissimilar metals includes the following steps. A first metal workpiece and a second metal workpiece having different physical characteristics are provided. A surface of the first metal workpiece and a surface of the second metal workpiece are abutted to form a pre joint surface between the first metal workpiece and the second metal workpiece. The first metal workpiece and the second metal workpiece are welded with a welding apparatus moving substantially along an axis, wherein the axis is offset from the pre joint surface and proximal to the first metal workpiece than to the second metal workpiece.

Although the present disclosure and its advantages have been described in detail, it should be understood that various changes, substitutions and alterations can be made herein without depart from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for welding dissimilar metals, comprising:
providing a first metal workpiece and a second metal workpiece having different physical characteristics;
abutting a surface of the first metal workpiece and a surface of the second metal workpiece to form a pre-joint surface between the first metal workpiece and the second metal workpiece; and
welding the first metal workpiece and the second metal workpiece with a welding apparatus moving substantially along an axis, wherein the axis is offset from the pre joint surface and proximal to the first metal workpiece than to the second metal workpiece.

2. The method of claim 1, wherein the first metal workpiece has a first coefficient of thermal conductivity, and the second metal workpiece has a second coefficient of thermal conductivity lower than the first coefficient of thermal conductivity;

3. The method of claim 1, wherein the welding apparatus comprises an arc welding apparatus.

4. The method of claim 3, wherein the arc welding apparatus comprises a gas tungsten arc welding (GTAW) apparatus.

5. The method of claim 1, wherein the axis is substantially in parallel with the pre joint surface.

6. The method of claim 1, wherein the pre joint surface is a planar surface.

7. The method of claim 1, wherein the pre-joint surface has a ring shape.

8. The method of claim 1, wherein the first metal workpiece and the second metal workpiece are plate workpieces.

9. The method of claim 1, wherein the first metal workpiece and the second metal workpiece are pipe workpieces.

10. The method of claim 1, wherein one of the first metal workpiece or the second metal workpiece is a plate workpiece, and the other one of the first metal workpiece or the second metal workpiece is a pipe workpiece.

11. The method of claim 1, wherein a material of the first metal workpiece comprises copper or an alloy thereof.

12. The method of claim 11, wherein the material of the first metal workpiece comprises copper chromium zirconium (CuCrZr) alloy, or oxygen-free high conductivity (OFHC) copper.

13. The method of claim 1, wherein a material of the second metal workpiece comprises stainless steel (SS).

14. The method of claim 1, wherein the welding apparatus is moved in a straightforward path along the axis.

15. The method of claim 1, wherein the welding apparatus is moved in a zigzag path along the axis.

16. The method of claim 1, wherein the pre joint surface is a seamless surface.
